(19) United States
(12) Patent Application Publication
(10) Pub. No.: US 2021/0354846 A1
(43) Pub. Date: Nov. 18, 2021

(54) LOAD CONTROL METHOD AND DEVICE

(71) Applicant: SZ DJI TECHNOLOGY CO., LTD., Shenzhen (CN)

(72) Inventors: Qiming LIU, Shenzhen (CN); Chaobin CHEN, Shenzhen (CN); Wei ZHOU, Shenzhen (CN)

(21) Appl. No.: 17/388,759

(22) Filed: Jul. 29, 2021

Related U.S. Application Data
(63) Continuation of application No. PCT/CN2019/073891, filed on Jan. 30, 2019.

(51) Int. Cl. B64D 43/02; B64D 1/18; B64D 47/08

(52) U.S. Cl. CPC B64D 43/02; B64D 1/18; B64C 2201/14; B64C 2201/127; B64D 47/08

(57) ABSTRACT

A load control method includes acquiring task information of a mobile platform mounted with a plurality of loads, determining a preset load from the plurality of loads according to the task information, and controlling a specified load of the plurality of loads to perform a corresponding operation with respect to a preset action based on a working state of the preset load. The task information is used to instruct the preset load to perform the preset action.

### CROSS-REFERENCE TO RELATED APPLICATION

This application is a continuation of International Application No. PCT/CN2019/073891, filed Jan. 30, 2019, the entire content of which is incorporated herein by reference.

### TECHNICAL FIELD

The present disclosure relates to the field of mobile platform and, in particular, to a load control method and a device.

### BACKGROUND

Currently, mobile platforms (e.g., aircrafts, mobile robots, etc.) can perform tasks based on preset task information. Taking the aircraft as an example, the aircraft can automatically perform flight guidance and route action control according to preset task information. In general, the aircraft is mounted with a load with a specific function, such as a camera or a sprayer, used to perform a flight action during a flight. For example, the camera takes photos at a first waypoint, or the sprayer sprays pesticides at a second waypoint. However, instructions of the mobile platform are sent to a specified load directly. In an event of a load failure, a corresponding task cannot be completed, resulting in a low execution rate.

### SUMMARY

In accordance with the disclosure, there is provided a load control method including acquiring task information of a mobile platform mounted with a plurality of loads, determining a preset load from the plurality of loads according to the task information, and controlling a specified load of the plurality of loads to perform a corresponding operation with respect to a preset action based on a working state of the preset load. The task information is used to instruct the preset load to perform the preset action.

Also in accordance with the disclosure, there is provided a load control device including a memory storing a program code, and a processor configured to execute the program code to acquire task information of a mobile platform mounted with a plurality of loads, determine a preset load from the plurality of loads according to the task information, and control a specified load of the plurality of loads to perform a corresponding operation with respect to a preset action based on a working state of the preset load. The task information is used to instruct the preset load to perform the preset action.

### BRIEF DESCRIPTION OF THE DRAWINGS

FIG. 1 is a schematic diagram of a load control system consistent with the embodiments of the present disclosure.

FIG. 2 is a schematic flow chart of a load control method consistent with the embodiments of the present disclosure.

FIG. 3 is a schematic flow chart of another load control method consistent with the embodiments of the present disclosure.

FIG. 4 is a schematic flow chart of another load control method consistent with the embodiments of the present disclosure.

FIG. 5 is a schematic flow chart of another load control method consistent with the embodiments of the present disclosure.

FIG. 6 is a schematic flow chart of another load control method consistent with the embodiments of the present disclosure.

FIG. 7 is a schematic flow chart of another load control method consistent with the embodiments of the present disclosure.

FIG. 8 is a schematic diagram of a load control device consistent with the embodiments of the present disclosure.

### DETAILED DESCRIPTION OF THE EMBODIMENTS

Technical solutions of the present disclosure will be clearly described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “a plurality of” used herein means more than two.

Some embodiments consistent with the present disclosure will be described with reference to the accompanying drawings. When there is no conflict, the following embodiments and the characteristics of the embodiments can be combined with each other.

A load control method consistent with the embodiments of the present disclosure is provided, which can be applied to a mobile platform mounted with a plurality of loads, and can also be applied to an electronic device. The electronic device is used to control the mobile platform. The electronic device may include, but is not limited to, a ground station, a remote control, etc. The mobile platform may include, but is not limited to, an aircraft, an unmanned vehicle, an unmanned ship, or a mobile robot. The control method includes acquiring a preset load indicated by task information of the mobile platform and controlling a specified load of the plurality of loads mounted at the mobile platform to perform a preset action based on a working state of the preset load. Therefore, the preset load can be selected from the plurality of loads, and the specified load of the plurality of loads can be scheduled to perform the preset action according to the working state of the preset load indicated by the task information, thereby improving a success rate of task execution of the mobile platform.

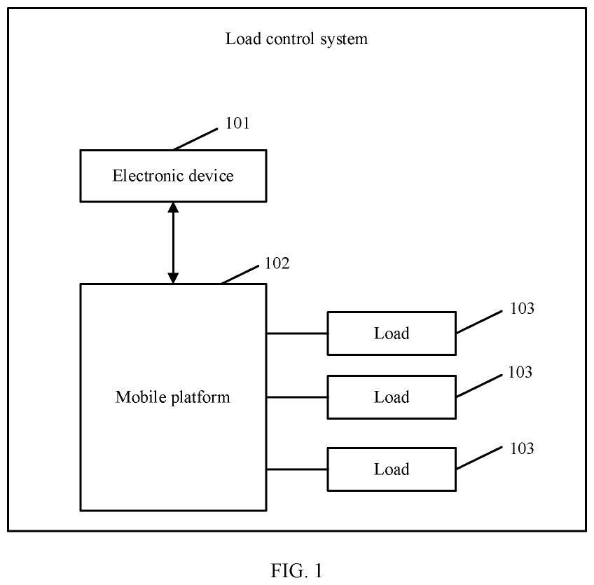

The load control method can be applied to a load control system. As shown in FIG. 1, the control system includes an electronic device 101 and a mobile platform 102. The mobile platform 102 is mounted with a plurality of loads 103. The electronic device 101 can be used to control the plurality of loads 103 mounted at the mobile platform 102 to perform preset actions. In some embodiments, the plurality of loads can be built-in on the mobile platform or can be externally placed on the mobile platform. The plurality of loads externally placed on the mobile platform can perform data interaction with the mobile platform through a communication port. The load externally placed on the mobile platform may include a camera, a gimbal, a sprayer, etc. The preset actions performed by the load can include imaging of the camera, video recording of the camera, rotation of the gimbal, spraying of the sprayer, etc.

In some embodiments, the load control method may be applied to the mobile platform. Taking the aircraft as an example, the aircraft is configured with a flight control system. After task information sent by the electronic device 101 is received, the aircraft can send the task information to the flight control system. The flight control system determines a preset load from a plurality of loads according to the task information and controls a specified load of the plurality of loads to perform a corresponding operation with respect to the preset action based on a working state of the preset load. In addition to the manners described above, the manner of acquiring the task information may also include others, which is not limited here. For example, the task information is stored in a local storage device of the aircraft.

In some embodiments, the load control method can also be applied to the electronic device 101. The electronic device 101 can perform data interaction with the mobile platform 102 to realize a control of the load mounted at the mobile platform 102. For example, the electronic device 101 may acquire the task information input by a user, or the electronic device 101 may acquire the task information from the mobile platform 102. The electronic device 101 can determine the preset load from the plurality of loads according to the task information. The electronic device 101 receives the working state of the preset load sent by the mobile platform 102 and controls the specified load of the plurality of loads to perform the corresponding operation with respect to the preset action based on the working state of the preset load. In addition to the manners described above, the manner of acquiring the task information may also include others, which is not limited here. For example, the task information is stored in a local storage device of the electronic device.

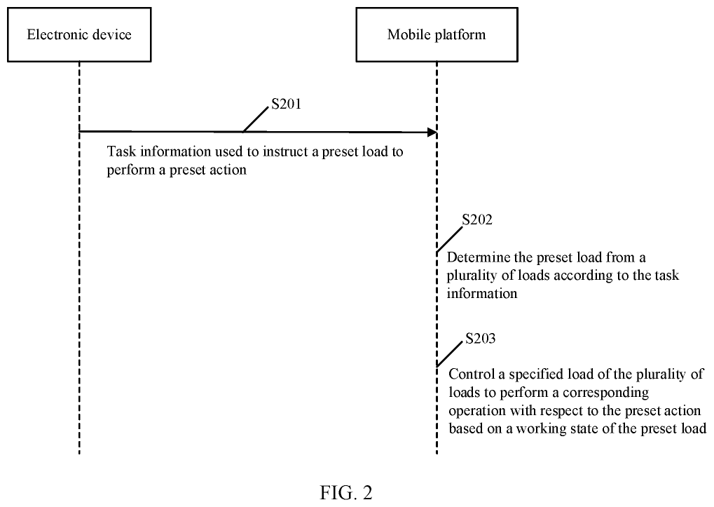

An example embodiment of the load control method will be described in detail below. The load control method is executed by an interaction between a mobile platform and an electronic device. As shown in FIG. 2, the specific implementation includes the following processes.

At S201, the mobile platform receives task information sent by the electronic device, and the task information is used to instruct a preset load to perform a preset action.

In the embodiments of the present disclosure, the mobile platform may receive the task information sent by the electronic device. The task information is used to instruct the load of the mobile platform to perform related operations. The task information may include movement route information of the mobile platform and execution action information of the load. The execution action information of the load may include, but is not limited to, a type of each of the plurality of loads, an identification of each of the plurality of loads, the preset action to be executed, and an execution parameter of the preset action, etc. The mobile platform can support the mounting of a plurality of loads of different types to achieve diversified functions (for example, mounting a camera to achieve an imaging function, mounting a sprayer to achieve a spraying function, etc.). The mobile platform can also support the mounting of a plurality of loads of a same type to schedule the plurality of loads of the same type to work together (for example, after a first camera takes five pictures, a second camera starts recording), and to realize a redundant backup function. The movement route information of the mobile platform and the execution action information of the load may not be related. That is, an action indicated by the execution action information of the load can be independent of a setting of the movement route information of the mobile platform, but can be executed during a movement process of the mobile platform.

In some embodiments, after the load is connected to the mobile platform, the mobile platform can identify the load currently connected, acquire parameter information of the load, and send the acquired parameter information of the load to the electronic device. The electronic device determines the preset action supported by the mobile platform based on the parameter information, such as a type, a number, and a mounting position, of the load currently connected, and generates corresponding task information by combining with the task that the user expects to perform.

For example, if the mobile platform is the aircraft, and the aircraft carries two cameras. Camera 1 and camera 2 are located under the nose of the aircraft, respectively. The preset action supported by the mobile platform may include taking photos at different angles by camera 1 and camera 2 together. Camera 2 can also be used as a redundant backup of camera 1. Further, when the preset action of camera 1 and camera 2 includes taking photos at different angles together, the execution parameter of the preset action of camera 1 may include taking a photo with a shooting angle in a northeast direction of the aircraft when the aircraft reaches a first waypoint, and the execution parameter of the preset action of camera 2 may include taking a photo with a shooting angle in a true north direction of the aircraft when the aircraft reaches the first waypoint. When the task of the aircraft is to acquire image information from a plurality of angles during a flight, the task information of the aircraft includes some of the content as shown in Table 1 below:

TABLE 1
Task information table

| Preset load | Preset action | Execution parameter of the preset action |
|---|---|---|
| Camera 1 | Taking a photo | Taking the photo with a shooting angle in |
| | | a northeast direction of the aircraft when |
| | | the aircraft reaches a first waypoint |
| Camera 2 | Taking a photo | Taking the photo with a shooting angle in |
| | | a true north direction of the aircraft when |
| | | the aircraft reaches the first waypoint |

The above task information table is only an example. A recording method of the task information is not limited to a table format, which is not limited here. The specific content of the above task information table can be generated correspondingly according to the load currently connected to the mobile platform and the preset action supported by the load. For example, when camera 2 is used as the redundant backup of camera 1, the execution parameters the preset action of camera 1 and camera 2 can all include taking the photo with the shooting angle in the northeast direction of the aircraft when the aircraft reaches the first waypoint, which are not limited here.

The execution parameter can be determined based on the preset action. In this scenario, the execution parameter can be customized by the user. When the preset action is the same and the execution parameters are different, a final execution result of the preset action can be different. For example, the user uses an interactive interface of the electronic device to view that the mobile platform carries four sprayers in four directions, which are south, east, north, and west. If a functional requirement of the user includes after 50 ml of pesticide is sprayed simultaneously using sprayer 1 and sprayer 2 to the east and west of the mobile platform, using sprayer 3 and sprayer 4 to spray 100 ml of pesticide to the south and north of the mobile platform simultaneously, then according to the functional requirement of the user, execution times of the preset actions of sprayer 3 and sprayer 4 are modified to be after the preset actions of sprayer 1 and sprayer 2 are completed, to realize the functional requirement of the user.

At S202, the mobile platform determines the preset load from the plurality of loads according to the task information.

The mobile platform determines the preset load for executing the related task from the plurality of loads currently connected to the mobile platform according to the execution action information of the load included in the task information. The task information is used to instruct the preset load to perform the preset action, and the preset load may be one or more of the loads mounted at the mobile platform. For example, the load mounted at the mobile platform may include, but is not limited to, a camera, a sprayer, a gimbal, or a radar, etc. If the task information is to control the camera to take photos and control the sprayer to spray pesticides, the preset loads determined from the plurality of loads include the camera and the sprayer.

At S203, the mobile platform controls a specified load of the plurality of loads to perform a corresponding operation with respect to the preset action based on a working state of the preset load.

The working state of the load may include, but is not limited to, a normal working state, an idle state, a fault state, or a pause state, etc. The normal working state means that the load is performing a specified action, that is, it is busy. The idle state means that the load is not performing any action. The fault state means that the load is faulty and cannot continue to perform any action. The pause state means that the load is paused to perform the specified action and can continue or not continue to perform the preset action. According to the above possible working states of the preset loads, the mobile platform can control the specified load of the plurality of loads to perform the corresponding operation with respect to the preset action. The specified load of the plurality of loads may include the preset load or the load of a same type as the preset load. Performing the corresponding operation with respect to the preset action may include executing the preset action or not executing the preset action.

In an example embodiment, during an operation of the mobile platform, when the preset load fails (for example, a device offline, a device hardware failure, etc.), the mobile platform can detect that the preset load is in the fault state, and the preset load cannot continue to perform the preset action, thereby affecting an overall task execution of the mobile platform. To ensure a success rate of tasks performed by the mobile platform, the redundant backup function can be used to control a backup load of the preset load to perform the corresponding operation with respect to the preset action. To realize the redundant backup function, in some embodiments, the plurality of loads mounted at the mobile platform may include at least two loads of a same type. For example, the aircraft may carry at least two cameras or carry at least two sprayers, to realize the redundant backup function. For example, if the preset load is camera 1, when the working state of camera 1 meets a condition for performing the preset action (for example, the working state of camera 1 is the idle state), the mobile platform controls camera 1 to perform the preset action (for example, taking a photo in the southeast direction of the aircraft). When the working state of camera 1 does not meet the condition for performing the preset action (for example, the working state of camera 1 is the fault state), the mobile platform controls a specified load (such as camera 2) of the same type as camera 1 and the working state thereof meets the condition for performing the preset action to perform the preset action to ensure the success of the task. When the working state of camera 1 is the fault state, the mobile platform can also control camera 1 not to perform the preset action, the task of the aircraft is terminated, and the aircraft can return home.

In an example embodiment, the plurality of loads mounted at the mobile platform may include loads of the same type. For example, the aircraft may be mounted with two cameras. During the flight, camera 1 can be scheduled to take photos, camera 2 can be scheduled to record videos. The loads of the same type perform different preset actions to achieve different functions.

In an example embodiment, the plurality of loads mounted at the mobile platform may also include loads of different types. For example, the aircraft may be mounted with two cameras and two sprayers simultaneously. During the flight, camera 1 is scheduled to take a photo at the first waypoint, camera 2 is scheduled to record a video at the second waypoint, sprayer 1 is scheduled to spray pesticides at the first waypoint, and sprayer 2 is scheduled to spray pesticides at the second waypoint, simultaneously. Thereby, the aircraft can achieve a plurality of specified functions during the flight.

The preset loads may include a plurality of loads of the same type, or a plurality of loads of different types. The plurality of preset loads of different types can execute the preset actions indicated by the task information, respectively. The mobile platform completes the task when the execution is completed. In some embodiments, the preset actions performed by the plurality of preset loads of the same type can be the same, but the execution parameters of the preset actions are different. For example, the preset loads are sprayer 1 and sprayer 2. The preset action of sprayer 1 includes spraying pesticides in a first flight area. The preset action of sprayer 2 includes spraying pesticides in a second flight area. The preset actions (spraying pesticide) of sprayer 1 and sprayer 2 are the same, but the execution parameters (sprayer 1 sprays 100 ml of pesticide to a lower right of the aircraft in the first flight area, and sprayer 2 sprays 50 ml of pesticide to a lower left of the aircraft in the second flight area) of the preset actions are different. In some embodiments, the preset actions performed by the plurality of preset loads of the same type may be different. For example, the preset loads are camera 1 and camera 2. The preset action of camera 1 includes taking photos, and the preset action of camera 2 includes recording videos. The two cameras can achieve different functions.

In some embodiments, the execution times of the plurality of preset loads can be correlated, that is, they are executed simultaneously, or the execution time of one execution action determines the execution times of another or more execution actions. For example, the preset load includes sprayer 1 and sprayer 2. The preset action of sprayer 1 is to spray 100 ml of pesticide to the lower right of the aircraft at the first waypoint, and the preset action of sprayer 2 is to spray 100 ml of pesticide to the lower right of the aircraft after sprayer 1 completes the preset action. The execution times of sprayer 1 and sprayer 2 are correlated.

In the embodiments of the present disclosure, the mobile platform receives the task information sent by the electronic device through the interaction between the electronic device and the mobile platform, and the mobile platform determines the preset load from the plurality of loads according to the task information and controls the specified load of the plurality of loads to perform the corresponding operation with respect to the preset action based on the working state of the preset load. The mobile platform can select the preset load from the plurality of loads and schedule the specified load to perform the preset action according to the working state of the preset load indicated by the task information, which can improve success rate of the task execution of the mobile platform.

The embodiments are described below to further expand the processes for controlling the specified load of the plurality of loads to perform the corresponding operation with respect to the preset action based on the working state of the preset load shown in FIG. 2.

In an example embodiment, when the working state of the preset load is a first working state, the preset load is controlled to perform the preset action. The first working state includes the normal working state or the idle state. When the preset load is in the normal working state or the idle state, the mobile platform can directly control the preset load to perform the preset action. For example, the mobile platform is the aircraft, and the preset load includes camera 1. The preset actions of camera 1 include taking the photo with the shooting angle in the northeast direction of the aircraft every five seconds in specified area 1 and taking the photo with the shooting angle in the true north direction of the aircraft every two seconds in specified area 2. During the flight of the aircraft, when camera 1 reaches specified area 2, if the working state of camera 1 is the idle state, camera 1 is controlled to perform the corresponding preset action. If the working state of camera 1 is the normal working state (for example, camera 1 has not finished taking the photo with the shooting angle in the northeast direction of the aircraft in specified area 1 every five seconds), then a next preset action is not executed until camera 1 completes the current preset action. In some embodiments, camera 1 can be forced to stop the current action and execute the next preset action.

In an example embodiment, when the working state of the preset load is a second working state, a backup load of the same type as the preset load from the plurality of loads is determined, and the backup load is controlled to execute the preset action. The second working state includes the normal working state or the fault state. When the preset load is in the normal working state or the fault state, the mobile platform can schedule the backup load of the preset load to perform the preset action through the redundant backup function. For example, the mobile platform is the aircraft, and the preset load includes camera 1. The preset actions of camera 1 include taking the photo with the shooting angle in the northeast direction of the aircraft every five seconds in specified area 1 and taking the photo with the shooting angle in the true north direction of the aircraft every two seconds in specified area 2. The aircraft is also mounted with camera 2 as the backup load of camera 1. The preset actions of camera 2 are the same as those of camera 1. When camera 1 is in the normal working state or the fault state, camera 2 is controlled to perform the preset actions. During the flight of the aircraft, when camera 1 reaches specified area 2, if the working state of camera 1 is the normal working state (for example, camera 1 has not finished taking the photo with the shooting angle in the northeast direction of the aircraft in specified area 1 every five seconds), the mobile platform controls camera 2 as the backup of camera 1 to continue to perform the preset action of camera 1, which is taking the photo with the shooting angle in the true north direction of the aircraft in specified area 2 every two seconds. If the working state of camera 1 is the fault state (for example, a connection between camera 1 and the aircraft is interrupted), the mobile platform controls camera 2 as the backup of camera 1 to perform the preset action.

In an example embodiment, when the working state of the preset load is a third working state, the preset load is controlled to refuse to perform the preset action. The third working state includes any one of the normal working state, the fault state, and the pause state. When the preset load is in any one of the normal working state, the fault state, and the pause state, the mobile platform can control the preset load to refuse to perform the preset action. For example, the mobile platform is the aircraft, and the preset load includes camera 1. The preset actions of camera 1 include taking the photo with the shooting angle in the northeast direction of the aircraft every five seconds in specified area 1 and taking the photo with the shooting angle in the true north direction of the aircraft every two seconds in specified area 2. When camera 1 is in any one of the normal working state, the fault state, and the pause state, the aircraft can directly control camera 1 not to perform the preset action, the task is terminated, and the aircraft can return home or continue to fly forward.

In an example embodiment, the task information is also used to instruct the preset load to perform the preset action when a preset trigger event occurs. That is, before the preset load executes the preset action, the mobile platform determines whether the corresponding preset trigger event occurs when the preset load executes the preset action. If the preset trigger event occurs, the mobile platform controls the specified load of the plurality of loads to perform the preset action based on the working state of the preset load. The preset trigger event indicates a trigger type and a trigger parameter. The trigger type includes, but is not limited to, at least one of a point trigger, a time trigger, or a specified area trigger. The corresponding trigger parameter is different according to different trigger type. The trigger parameter corresponding to the point trigger includes a predetermined location. The trigger parameter corresponding to the time trigger includes a first movement index parameter, a second movement index parameter, and a time interval. The trigger parameter corresponding to the specified area trigger includes a longitude parameter, a latitude parameter, and an altitude parameter.

For example, the mobile platform is the aircraft, and the load includes two cameras and two gimbals. The two cameras are mounted at the two gimbals, respectively, that is, camera 1 is mounted at gimbal 1, and camera 2 is mounted at gimbal 2. If the preset load includes camera 1 and gimbal 1, the preset action of camera 1 includes recording a video in a southeast direction of the aircraft in the first flight area, and the preset action of gimbal 1 is rotating from a true south direction of the aircraft to the southeast direction of the aircraft when the aircraft reaches the first waypoint. The first waypoint is a boundary point where the aircraft enters the first flight area. The preset trigger event of camera 1 includes entering the first flight area and the gimbal rotates to the southeast direction of the aircraft. The preset trigger event of gimbal 1 includes reaching the first waypoint. The preset trigger event corresponding to the preset load may include a single trigger event or a trigger event associated with other preset loads, which is not limited here.

If the preset trigger event occurs, the mobile platform controls the specified load of the plurality of loads to perform the preset action based on the working state of the preset load. Specifically, when the preset load is in any one of the first working state, the second working state, and the third working state, for the specific implementations of the mobile platform controlling the specified load of the plurality of loads to perform the preset action based on the working state of the preset load, reference may be made to the description of the above embodiments, which are omitted here.

When the preset load is in a different working state, the mobile platform controls the specified load of the plurality of loads to perform the corresponding operation with respect to the preset action according to the working state of the preset load. The specified load may include the preset load or the load of the same type as the preset load. Performing the corresponding operation with respect to the preset action may include performing the preset action or refusing to perform the preset action. A plurality of implementation solutions are provided for the mobile platform to control the plurality of loads to perform the preset actions. When the preset load is in the different working state, the mobile platform can be controlled to implement corresponding functions, which improves the success rate of the task execution of the mobile platform.

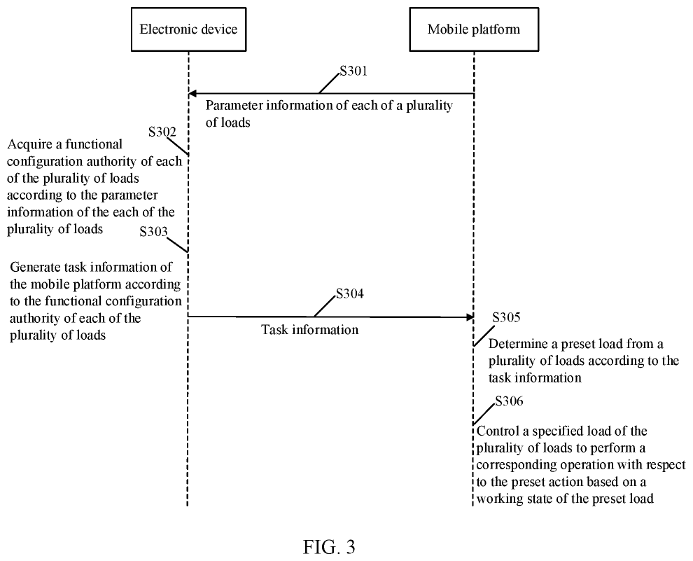

Another example embodiment of the load control method consistent with the present disclosure is provided. The load control method is executed as interaction between the mobile platform and the electronic device. The task information is configured by the electronic device based on functional configuration authorities of the plurality of loads. As shown in FIG. 3, the specific implementation includes the following processes.

At S301, the electronic device acquires parameter information of each of the plurality of loads from the mobile platform.

The electronic device can acquire the parameter information of each of the plurality of loads mounted at the mobile platform. The parameter information of each of the plurality of loads includes the type of each of the plurality of loads, the mounting position of each of the plurality of loads at the mobile platform, performance parameters of each of the plurality of loads, and the number of loads of the same type, etc. The parameter information of each of the plurality of loads is used to prompt the electronic device of the functions that the mobile platform can implement and the actions that need to be performed to implement the functions. For example, the mobile platform is the aircraft, and the loads include two cameras and two gimbals. Gimbal 1 and gimbal 2 are mounted at the nose of the aircraft, and camera 1 and camera 2 are mounted at gimbal 1 and gimbal 2, respectively. The functions that the mobile platform can achieve include taking photos by camera 1 and camera 2 together and splicing the photos, using camera 2 as the redundant backup of camera 1, and realizing multi-angle shooting of the camera by controlling the rotation of the gimbal.

At S302, the electronic device acquires the functional configuration authority of each of the plurality of loads according to the parameter information of the each of the plurality of loads.

The electronic device can acquire the preset actions supported by each of the plurality of loads by acquiring the parameter information of the each of the plurality of loads, and request the mobile platform for the functional configuration authority of each of the plurality of loads according to the preset actions supported by the each of the plurality of loads. For example, the mobile platform is the aircraft, and the loads include two cameras and two gimbals. Gimbal 1 and gimbal 2 are mounted at the nose of the aircraft, and camera 1 and camera 2 are mounted at gimbal 1 and gimbal 2, respectively. The functions that the mobile platform can achieve include taking photos by camera 1 and camera 2 together and splicing the photos, using camera 2 as the redundant backup of camera 1, and realizing multi-angle shooting of the camera by controlling the rotation of the gimbal. According to the preset actions supported by the loads, the electronic device can acquire functional configuration authority of the camera for a collaborative photographing function, the functional configuration authority of the camera for a redundant backup function, and the functional configuration authority of the gimbal for a rotation function.

In an example embodiment, the parameter information of each of the plurality of loads may also be updated according to an operation instruction and/or a change of the load. In some embodiments, after the electronic device acquires the parameter information of each of the plurality of loads, the electronic device can display the parameter information of each of the plurality of loads on the interactive interface. The user can view the parameter information of each of the plurality of loads and input the operation instruction according to an actual functional requirement of the user. The electronic device sends the operation instruction to the mobile platform. The mobile platform modifies the parameter information of the each of the plurality of loads to realize a specified function. The operation instruction may include modifying the parameter information of a first load among the plurality of loads, deleting the parameter information of a second load among the plurality of loads, replacing a third load among the plurality of loads with a replacement load and saving the parameter information of a replacement load, and adding the parameter information of a fourth load. The change of the load may include replacements one or more loads among the plurality of loads, a decrease in the number of the plurality of loads, an increase in the number of the plurality of loads, and appearances of one or more invalid loads (invalid loads include, but are not limited to, hardware failure loads and loads that cannot establish a communicational connection with the mobile platform) among the plurality of loads.

In some embodiments, after a configuration of the task information of the mobile platform is completed, if the mobile platform detects that one or more loads are disconnected from the mobile platform, then the mobile platform updates the parameter information according to the change of the load, and deletes the parameter information corresponding to the one or more disconnected loads. For example, after the configuration of the task information of the mobile platform is completed, one or more loads are replaced (for example, a camera without a recording function is replaced by a camera with a recording function), the mobile platform updates the parameter information according to the change of the load, deletes the parameter information corresponding to the load being replaced, and adds the parameter information corresponding to the replacement load.

Processes S301 to S302 can also be executed by the mobile platform. The mobile platform can output the functional configuration authority to the electronic device. The electronic device provides the user with the configuration of the task information in an output manner, such as displaying.

At S303, the electronic device generates the task information of the mobile platform according to the functional configuration authority of each of the plurality of loads.

The electronic device can generate the task information for the mobile platform by combining with the actual functional requirement of the user based on the acquired functional configuration authority of each of the plurality of loads. For example, the mobile platform is the aircraft, the plurality of loads include two cameras. The functional configuration authorities of camera 1 and camera 2 both include taking photos and recording videos. In this scenario, the electronic device receives the functional requirement of the user including taking a plurality of photos by a camera in a specified flight area and recording a video by another camera for the entire flight. The electronic device then generates the task information of the mobile platform according to the functional configuration authorities of the cameras and the functional requirements of the user. The task information includes taking five photos by camera 1 in the first flight area, and recording a video by camera 2 in the first flight area and the second flight area.

In an example embodiment, during a process of the configuration of the task information, when the task information is detected to be abnormal, the electronic device outputs second prompt information. The second prompt information is used to prompt that the task information is abnormal. The electronic device determines a correctness of the configuration of the task information. If the task information is abnormal, the electronic device gives a corresponding prompt until all actions are correctly configured. The task information being abnormal includes whether the preset load and/or preset action is valid indicated in the task information. For example, the preset loads indicated in the task information include camera 1 and camera 2, the preset action of camera 1 includes taking the photo. Camera 2 is used as a backup of camera 1, and the preset action of camera 2 also includes taking the photo. If the electronic device detects that the preset action of camera 2 is video recording, then the configuration of the backup function of camera 1 fails, the preset action of camera 2 is invalid. The electronic device may output a prompt message that the task information is abnormal, modify the configuration information of camera 2, and modify the preset action of camera 2 as taking the photo.

At S304, the electronic device sends the task information to the mobile platform.

According to process S303, the electronic device generates the task information of the mobile platform by combining with the functional requirement of the user according to the acquired functional configuration authority of each of the plurality of loads. The task information is used to instruct the preset load of the mobile platform to perform the preset action. The mobile platform can receive the task information sent by the electronic device and perform the corresponding operation according to the task information.

At S305, the mobile platform determines the preset load from the plurality of loads according to the task information. For details of process S305 consistent with the embodiments of the present disclosure, reference may be made to process S202 shown in FIG. 2, which is omitted here.

At S306, the mobile platform controls the specified load of the plurality of loads to perform the corresponding operation with respect to the preset action based on the working state of the preset load. For details of process S306 consistent with the embodiments of the present disclosure, reference may be made to process S203 shown in FIG. 2, which is omitted here.

In another example embodiment of the load control method consistent with the present disclosure, on a premise that the task information is configured based on the functional configuration authority of the plurality of loads, the electronic device acquires the parameter information of each of the plurality of loads of the mobile platform, acquires the functions that can be realized by the mobile platform according to the parameter information of each of the plurality of loads to acquire the functional configuration authority of the each of the plurality of loads, and generates the task information of the mobile platform according to the functional configuration authority. The mobile platform then controls the plurality of loads to perform the corresponding operation according to the task information. That is, the electronic device can pre-configure the functions of the plurality of loads of the mobile platform according to the functions that can be realized by the mobile platform, generate the task information, and send the task information to the mobile platform. The mobile platform controls the preset load to perform the preset action according to the task information to achieve the corresponding function.

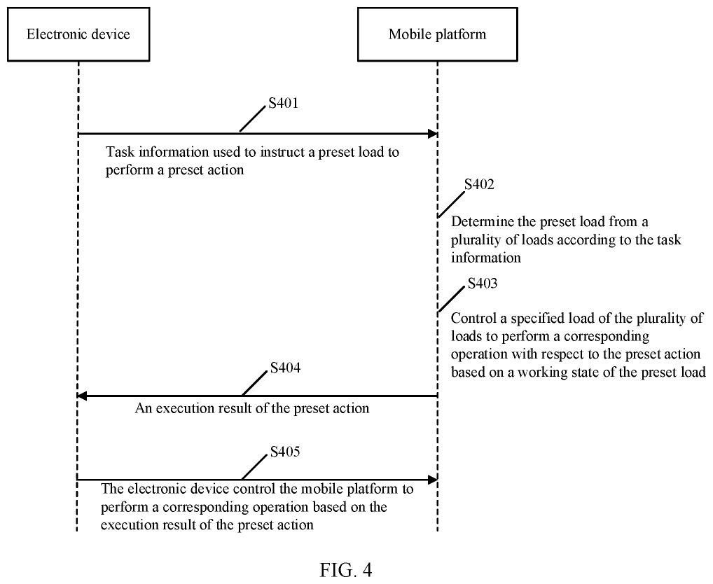

Another load control method consistent with the embodiments of the present disclosure is provided. When the mobile platform controls the specified load of the plurality of loads to perform the corresponding operation with respect to the preset action or after the operation is completed, the electronic device can acquire an execution result of the preset action to detect whether the specified load performs the preset action correctly. FIG. 4 is a schematic flow chart of another load control method consistent with the embodiments of the present disclosure. The load control method shown in FIG. 4 is executed as interaction between the mobile platform and the electronic device and includes the following processes.

At S401, the mobile platform receives task information sent by the electronic device. The task information is used to instruct a preset load to perform a preset action. For details of process S401 consistent with the embodiments of the present disclosure, reference may be made to process S201 shown in FIG. 2, which is omitted here.

At S402, the mobile platform determines the preset load from a plurality of loads according to the task information. For details of process S402 consistent with the embodiments of the present disclosure, reference may be made to process S202 shown in FIG. 2, which is omitted here.

At S403, the mobile platform controls a specified load of the plurality of loads to perform a corresponding operation with respect to the preset action based on the working state of the preset load. For details of process S403 consistent with the embodiments of the present disclosure, reference may be made to process S203 shown in FIG. 2, which is omitted here.

At S404, the mobile platform sends an execution result of the preset action to the electronic device.

When the mobile platform controls the specified load to perform the corresponding operation with respect to the preset action or when the execution is completed, the mobile platform may send the execution result of the preset action to the electronic device and output the execution result of the preset action. In some embodiments, the electronic device receives the execution result of the preset action of the preset load in real time and displays the execution result on the interactive interface. The user can view the execution result of the preset action in real time. In some embodiments, after the mobile platform controls the specified load to perform the corresponding operation with respect to the preset action, the mobile platform sends the execution result of the preset action to the electronic device. The electronic device displays the execution result on the interactive interface for the user to view.

At S405, the electronic device controls the mobile platform to perform a corresponding operation according to the execution result of the preset action.

The electronic device can acquire the execution result of the preset action to determine whether the mobile platform completes the task as required. If the mobile platform completes the task as required, the electronic device displays, on the interactive interface, the execution result that the mobile platform controls the specified load to perform the preset action according to the task information. The user can view the execution result through the interactive interface. If the mobile platform does not work as required, the user can also send a control instruction to the mobile platform through the electronic device. The control instruction is used to control the specified load that does not work as required to stop performing the preset action, that is, interrupt or pause the execution of the preset action, modify the execution parameters of the preset action according to the control instruction of the user, and then control the specified load to continue to perform the preset action. For example, the aircraft is mounted with two sprayers, and the preset load is sprayer 1. The preset action of sprayer 1 is spraying pesticides in the first flight area. If sprayer 1 does not perform the preset action of spraying pesticides when aircraft flies to the first flight area, then the electronic device displays the execution result of sprayer 1 on the interactive interface. The user can choose to send a task interruption instruction to the mobile platform through the electronic device and control the aircraft to return home, or choose to send a task pause instruction to the mobile platform through the electronic device and schedule sprayer 2 to perform the preset action of sprayer 1.

In the embodiments of the present disclosure, when the mobile platform controls the specified load of the plurality of loads to perform the corresponding operation with respect to the preset action or after the operation is completed, the electronic device can acquire the execution result of the preset action. The electronic device can also control the mobile platform to perform the corresponding operation according to the execution result of the preset action. If the preset load does not perform the preset action as required, the electronic device can control the mobile platform to use the redundant backup to complete the task. Thereby, the task execution result of the mobile platform can be monitored and the success rate of the task execution of the mobile platform can be improved.

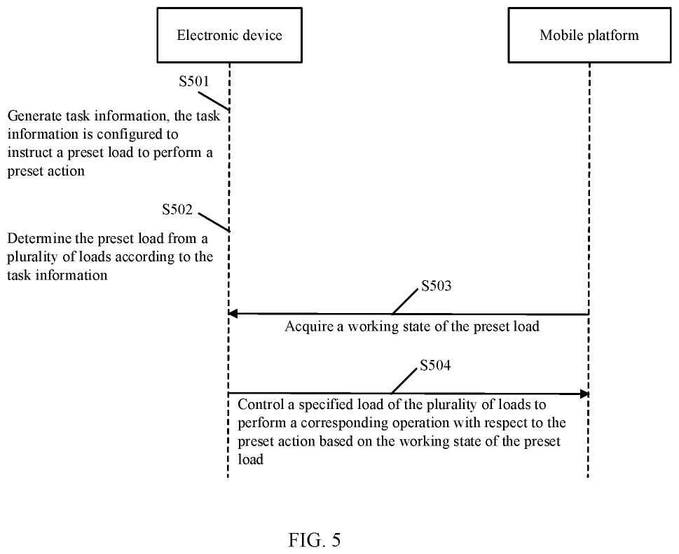

Another load control method consistent with the embodiments of the present disclosure is provided. As shown in FIG. 5, the load control method is executed as interaction between the mobile platform and the electronic device and includes the following processes.

At S501, the electronic device generates task information. The task information is used to instruct a preset load to perform a preset action.

For details of process S501 consistent with the embodiments of the present disclosure, reference may be made to process S201 shown in FIG. 2, which is omitted here.

At S502, the electronic device determines the preset load from a plurality of loads according to the task information.

For details of process S502 consistent with the embodiments of the present disclosure, reference may be made to process S202 shown in FIG. 2, which is omitted here.

At S503, the electronic device acquires a working state of the preset load from the mobile platform.

At S504, the electronic device controls a specified load of the plurality of loads to perform a corresponding operation with respect to the preset action based on the working state of the preset load.

Specifically, the electronic device sends a control instruction to the mobile platform to control the specified load to perform the corresponding operation with respect to the preset action. The control instruction includes an identification of the specified load and the preset action. In an actual operation, the mobile platform controls the specified load to perform the corresponding operation with respect to the preset actions according to the control instruction sent by the electronic device.

In the embodiments of the present disclosure, the electronic device can acquire the task information of the mobile platform through the interaction between the electronic device and the mobile platform, determine the preset load from the plurality of loads according to the task information, and control the specified load of the plurality of loads to perform the corresponding operation with respect to the preset action based on the working state of the preset load. Thereby, the specified load can be scheduled to perform the preset action according to the working state of the preset load indicated by the task information, to improve the success rate of the task execution of the mobile platform.

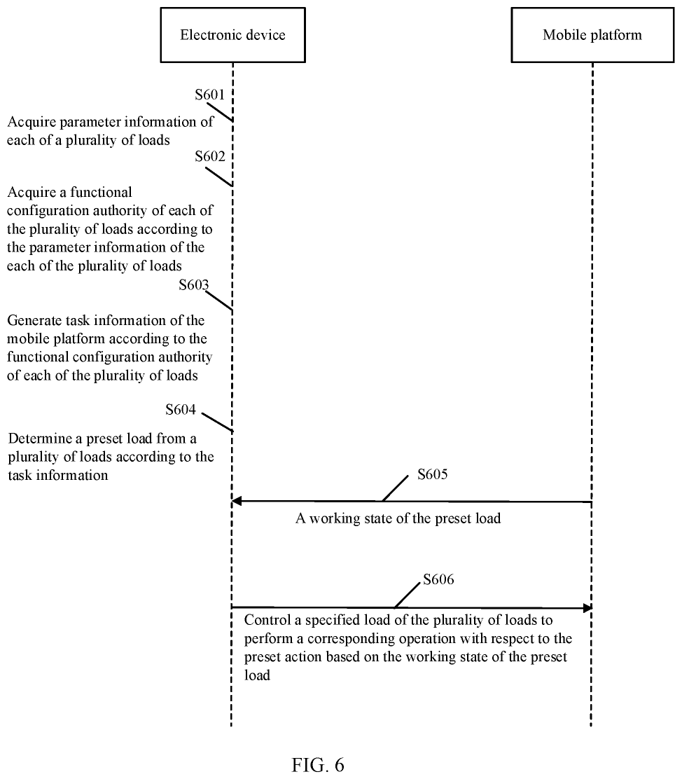

Another load control method consistent with the embodiments of the present disclosure is provided. As shown in FIG. 6, the load control method is executed as interaction between the mobile platform and the electronic device and includes the following processes.

At S601, the electronic device acquires parameter information of each of a plurality of loads.

The user can input the parameter information of each of the plurality of loads mounted at the mobile platform through a user interface of the electronic device. The electronic device can acquire the parameter information of each of the plurality of loads.

At S602, the electronic device acquires functional configuration authority of each of the plurality of loads according to the parameter information of the each of the plurality of loads.

At S603, the electronic device generates task information of the mobile platform according to the acquired functional configuration authority of each of the plurality of loads.

For details of process S603 consistent with the embodiments of the present disclosure, reference may be made to process S303 shown in FIG. 3, which is omitted here.

At S604, the electronic device determines a preset load from the plurality of loads according to the task information.

At S605, the electronic device acquires a working state of the preset load from the mobile platform.

At S606, the electronic device controls a specified load of the plurality of loads to perform a corresponding operation with respect to the preset action based on the working state of the preset load.

In the embodiments of the present disclosure, the electronic device acquires the parameter information of each of the plurality of loads of the mobile platform, acquires the functional configuration authority of each of the plurality of loads according to the parameter information of the each of the plurality of loads, and generates the task information according to the functional configuration authority for the mobile platform. Thereby, the electronic device can pre-configure functions of the plurality of loads of the mobile platform according to the functions that can be implemented by the mobile platform. The mobile platform can control the preset load to perform the preset action according to the preset task information during the movement, to realize the corresponding function.

In addition to the embodiments described above, the execution body of each process in the above embodiments may also include others. In some embodiments, the execution body of each process may be the same or different. For example, the mobile platform and the electronic device, via a communicational connection between the mobile platform and the electronic device, may perform the corresponding processes alternately. The above-described embodiments are only examples for illustration, which are not limited here.

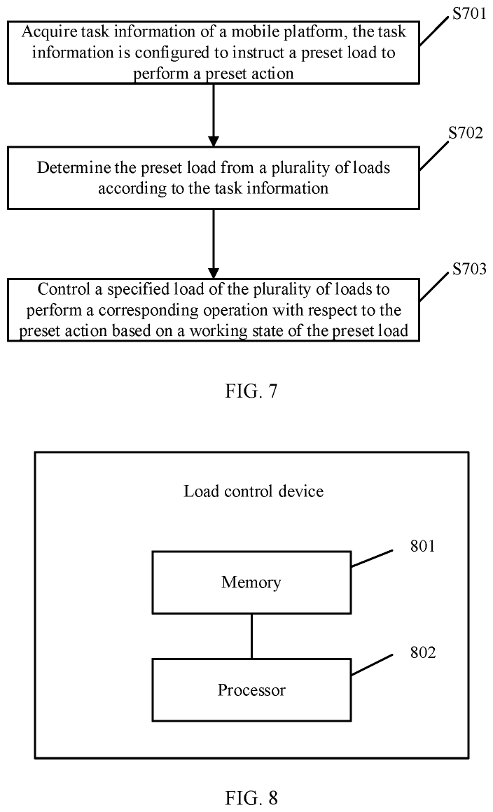

Another load control method consistent with the embodiments of the present disclosure is provided. As shown in FIG. 7, the load control method includes the following processes.

At S701, task information of the mobile platform is acquired. The task information is used to instruct a preset load to perform a preset action.

The mobile platform can receive the task information sent by the electronic device. In some embodiments, after the load is connected to the mobile platform, the mobile platform can identify the load currently connected, acquire parameter information of the load, and send the acquired parameter information of the load to the electronic device. The electronic device determines the preset action supported by the mobile platform based on the parameter information, such as a type, a number, and a mounting position, of the load currently connected, and generates corresponding task information by combining with the task that the user expects to perform.

At S702, the preset load is determined from a plurality of loads according to the task information.

The mobile platform determines the preset load for executing the related task from the plurality of loads currently connected to the mobile platform according to the execution action information of the load included in the task information. The task information is used to instruct the preset load to perform the preset action, and the preset load may be one or more of the loads mounted at the mobile platform. For example, the load mounted at the mobile platform may include, but is not limited to, a camera, a sprayer, a gimbal, or a radar, etc. If the task information is to control the camera to take photos and control the sprayer to spray pesticides, the preset loads determined from the plurality of loads include the camera and the sprayer.

At S703, a specified load of the plurality of loads is controlled to perform a corresponding operation with respect to the preset action based on a working state of the preset load.

The working state of the load may include, but is not limited to, a normal working state, an idle state, a fault state, or a pause state, etc. The normal working state means that the load is performing a specified action, that is, it is busy. The idle state means that the load is not performing any action. The fault state means that the load is faulty and cannot continue to perform any action. The pause state means that the load is paused to perform the specified action and can continue or not continue to perform the preset action. According to the above possible working states of the preset loads, the mobile platform can control the specified load of the plurality of loads to perform the corresponding operation with respect to the preset action. The specified load of the plurality of loads may include the preset load or the load of a same type as the preset load. Performing the corresponding operation with respect to the preset action may include executing the preset action or not executing the preset action.

In an example embodiment, when the working state of the preset load is a first working state, the preset load is controlled to perform the preset action. The first working state includes the normal working state or the idle state. When the preset load is in the normal working state or the idle state, the mobile platform can directly control the preset load to perform the preset action. For example, the mobile platform is the aircraft, and the preset load includes camera 1. The preset actions of camera 1 include taking the photo with the shooting angle in the northeast direction of the aircraft every five seconds in specified area 1 and taking the photo with the shooting angle in the true north direction of the aircraft every two seconds in specified area 2. During the flight of the aircraft, when camera 1 reaches specified area 2, if the working state of camera 1 is the idle state, camera 1 is controlled to perform the corresponding preset action. If the working state of camera 1 is the normal working state (for example, camera 1 has not finished taking the photo with the shooting angle in the northeast direction of the aircraft in specified area 1 every five seconds), then a next preset action is not executed until camera 1 completes the current preset action. In some embodiments, camera 1 can be forced to stop the current action and execute the next preset action.

In an example embodiment, when the working state of the preset load is a second working state, a backup load of the same type is determined from the plurality of loads as the preset load, and the backup load is controlled to execute the preset action. The second working state includes the normal working state or the fault state. When the preset load is in the normal working state or the fault state, the mobile platform can schedule the backup load of the preset load to perform the preset action through the redundant backup function. For example, the mobile platform is the aircraft, and the preset load includes camera 1. The preset actions of camera 1 include taking the photo with the shooting angle in the northeast direction of the aircraft every five seconds in specified area 1 and taking the photo with the shooting angle in the true north direction of the aircraft every two seconds in specified area 2. The aircraft is also mounted with camera 2 as the backup load of camera 1. The preset actions of camera 2 are the same as those of camera 1. When camera 1 is in the normal working state or the fault state, camera 2 is controlled to perform the preset actions. During the flight of the aircraft, when camera 1 reaches specified area 2, if the working state of camera 1 is the normal working state (for example, camera 1 has not finished taking the photo with the shooting angle in the northeast direction of the aircraft in specified area 1 every five seconds), the mobile platform controls camera 2 as the backup of camera 1 to continue to perform the preset action of camera 1, which is taking the photo with the shooting angle in the true north direction of the aircraft in specified area 2 every two seconds. If the working state of camera 1 is the fault state (for example, a connection between camera 1 and the aircraft is interrupted), the mobile platform controls camera 2 as the backup of camera 1 to perform the preset action.

In an example embodiment, when the working state of the preset load is a third working state, the preset load is controlled to refuse to perform the preset action. The third working state includes any one of the normal working state, the fault state, and the pause state. When the preset load is in any one of the normal working state, the fault state, and the pause state, the mobile platform can control the preset load to refuse to perform the preset action. For example, the mobile platform is the aircraft, and the preset load includes camera 1. The preset actions of camera 1 include taking the photo with the shooting angle in the northeast direction of the aircraft every five seconds in specified area 1 and taking the photo with the shooting angle in the true north direction of the aircraft every two seconds in specified area 2. When camera 1 is in any one of the normal working state, the fault state, and the pause state, the aircraft can directly control camera 1 not to perform the preset action, the task is terminated, and the aircraft can return home or continue to fly forward.

In the embodiments of the present disclosure, the preset load can be selected from the plurality of loads, the specified load can be scheduled to perform the preset action according to the working state of the preset load indicated by the task information, thereby improving the success rate of the task execution of the mobile platform.

Based on the description of the above embodiments of the load control method, a load control device consistent with the embodiments of the present disclosure is provided. A plurality of the loads are mounted at a mobile platform. The load control method shown in FIGS. 2-7 can be applied to the load control device. The load control device can perform the corresponding processes of the load control method described above. As shown in FIG. 8, the device includes a memory 801 and a processor 802. The memory 801 stores a program code. The processor 802 is configured to execute the program code to acquire task information of the mobile platform, determine a preset load from the plurality of loads according to the task information, and control a specified load of the plurality of loads to perform a corresponding operation on a preset action based on a working state of the preset load. The task information is used to instruct the preset load to perform the preset action.

In an example embodiment, the plurality of loads include at least two loads of a same type.

In some embodiments, the preset load is included in a plurality of preset loads. At least two of the plurality of preset loads are of the same type. The preset actions corresponding to the at least two preset loads of the same type are different.

In some embodiments, the preset load is included in the plurality of preset loads. At least two of the plurality of preset loads are of the same type. The preset actions corresponding to the at least two preset loads of the same type are same.

In some embodiments, execution parameters of the preset actions corresponding to the at least two preset loads of the same type are different.

In some embodiments, the execution times of the preset actions corresponding to the at least two preset loads are correlated.

In some embodiments, the processor 802 is further configured to execute the program code to control the preset load to perform the preset action when the working state of the preset load is a first working state.

In some embodiments, the first working state includes a normal working state or an idle state.

In some embodiments, the processor 802 is further configured to execute the program code to determine a backup load of a same type as the preset load from the plurality of loads and control the backup load to perform the preset action when the working state of the preset load is a second working state.

In some embodiments, the second working state includes a normal working state or a fault state.

In some embodiments, the processor 802 is further configured to execute the program code to control the preset load to refuse to perform the preset action when the working state of the preset load is a third working state.

In some embodiments, the processor 802 is further configured to execute the program code to output first prompt information when the working state of the preset load is the third working state. The first prompt information is used to prompt the preset load to refuse to perform the preset action.

In some embodiments, the third working state includes any one of a normal working state, a fault state, and a pause state.

In some embodiments, the task information is configured based on a plurality of functional configuration authorities of the plurality of loads.

In some embodiments, the processor 802 is further configured to execute the program code to acquire parameter information of each of the plurality of loads, acquire the functional configuration authority of each of the plurality of loads according to the parameter information of the each of the plurality of loads, and output the functional configuration authority.

In some embodiments, the processor 802 is further configured to execute the program code to acquire the preset actions supported by each of the plurality of loads according to the parameter information of the each of the plurality of loads, and acquire the functional configuration authority of each of the plurality of loads according to the preset actions supported by the each of the plurality of loads.

In some embodiments, the parameter information includes at least one of a type of each of the plurality of loads, a mounting position of each of the plurality of loads at the mobile platform, and performance parameters of each of the plurality of loads, or a number of loads of a same type.

In some embodiments, the parameter information of each of the plurality of loads is stored in a preset storage device, and the parameter information is updated based on at least one of an operation instruction or a change of the load.

In some embodiments, the processor 802 is further configured to execute the program code to detect whether the task information is abnormal and output prompt information when the task information is abnormal. The prompt information is used to prompt that the task information is abnormal.

In some embodiments, the processor 802 is further configured to execute the program code to detect whether the task information is abnormal during a process of configuration of the task information.

In some embodiments, the processor 802 is further configured to execute the program code to detect whether the preset load and/or the preset action indicated in the task information are valid, and determine that the task information is abnormal if the preset load is invalid or the preset action is invalid.

In some embodiments, the task information is used to instruct the preset load to perform the preset action when a preset trigger event occurs. the processor 802 is further configured to execute the program code to control the specified load of the plurality of loads to perform the corresponding operation with respect to the preset action based on the working state of the preset load when the preset trigger event occurs.

In some embodiments, the processor 802 is further configured to execute the program code to output an execution result of the preset action.

In some embodiments, the processor 802 is further configured to execute the program code to control the mobile platform to stop executing the preset action when the execution result of the preset action does not meet an expected result.

In some embodiments, the load control device is applied to a mobile platform or an electronic device. The mobile platform includes an aircraft, an unmanned vehicle, an unmanned ship, or a mobile robot. The electronic device includes a ground station or a remote control.

In some embodiments, the load includes at least one of a gimbal, a spraying device, an imaging device, or a distance measurement device.

In the embodiments of the present disclosure, the load control device can acquire the task information, determine the preset load from the plurality of loads according to the task information, and control the specified load of the plurality of loads to perform the corresponding operation with respect to the preset action based on the working state of the preset load, thereby improving the success rate of the task execution of the mobile platform.

Those of ordinary skill in the art will appreciate that all or some of the processes in the above-described method embodiments can be implemented by a program instructing relevant hardware. The above-described program can be stored in a computer-readable storage medium. When the program is executed, the processes in the above-described method embodiments is executed. The storage medium can include a magnetic disk, an optical disk, a read-only memory (ROM), or a random access memory (RAM).

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A load control method comprising:
acquiring task information of a mobile platform mounted with a plurality of loads, the task information being configured to instruct a preset load to perform a preset action;
determining the preset load from the plurality of loads according to the task information; and
controlling a specified load of the plurality of loads to perform a corresponding operation with respect to the preset action based on a working state of the preset load.

2. The method of claim 1, wherein the plurality of loads include at least two loads of a same type.

3. The method of claim 2, wherein the preset load is one of a plurality of preset loads, at least two preset loads of the plurality of preset loads are of a same type, and the preset actions corresponding to the at least two preset loads of the same type are different.

4. The method of claim 2, wherein the preset load is one of a plurality of preset loads, at least two preset loads of the plurality of preset loads are of a same type, and the preset actions corresponding to the at least two preset loads of the same type are same.

5. The method of claim 4, wherein execution parameters of the preset actions corresponding to the at least two preset loads of the same type are different.

6. The method of claim 3, wherein execution times of the preset actions corresponding to the at least two preset loads are correlated.

7. The method of claim 1, wherein controlling the specified load of the plurality of loads to perform the corresponding operation based on the working state of the preset load includes at least one of:
in response to the working state of the preset load being a first working state, controlling the preset load to perform the preset action;
in response to the working state of the preset load being a second working state:
determining a backup load from the plurality of loads, the backup load being of a same type as the preset load; and
controlling the backup load to perform the preset action; or
in response to the working state of the preset load being a third working state, controlling the preset load to refuse to perform the preset action.

8. The method of claim 7, wherein controlling the preset load to perform the corresponding operation based on the working state of the preset load further includes:
in response to the working state of the preset load being the third working state, outputting prompt information, the prompt information being configured to prompt the preset load to refuse to perform the preset action.

9. The method of claim 7, wherein:
the first working state includes at least one of a normal working state or an idle state;
the second working state includes at least one of a normal working state or a fault state; and
the third working state includes at least one of a normal working state, a fault state, or a pause state.

10. The method of claim 1, wherein the task information is configured based on a plurality of functional configuration authorities of the plurality of loads.

11. The method of claim 10, further comprising, before acquiring the task information, for each load of the plurality of loads:
acquiring parameter information of the load;
acquiring a functional configuration authority of the load according to the parameter information of the load; and
outputting the functional configuration authority.

12. The method of claim 11, wherein acquiring the functional configuration authority of the load according to the parameter information of the load includes:
acquiring a preset action supported by the load according to the parameter information of the load; and
acquiring the functional configuration authority of the load according to the preset action supported by the load.

13. The method of claim 11, wherein:
the parameter information of the load includes at least one of a type of the load, a mounting position of the load at the mobile platform, a performance parameter of the load, or a number of loads that are of a same type as the load;
the parameter information of the load is stored in a preset storage device; and
the parameter information is updated based on at least one of an operation instruction or a change of the load.

14. The method of claim 10, further comprising:
detecting whether the task information is abnormal; and
in response to the task information being abnormal, outputting prompt information, the prompt information being configured to prompt that the task information is abnormal.

15. The method of claim 14, wherein detecting whether the task information is abnormal includes:
detecting whether at least one of the preset load or the preset action indicated in the task information is valid; and
in response to the at least one of the preset load or the preset action being invalid, determining that the task information is abnormal.

16. The method of claim 1, wherein:
the task information is further configured to instruct the preset load to perform the preset action in response to a preset trigger event;
controlling the specified load to perform the corresponding operation based on the working state of the preset load includes:
in response to the preset trigger event, controlling the specified load to perform the corresponding operation based on the working state of the preset load.

17. The method of claim 1, further comprising:
outputting an execution result of the preset action.

18. The method of claim 1, wherein the load includes at least one of a gimbal, a spraying device, an imaging device, or a distance measurement device.

19. A load control device comprising:
a memory storing a program code; and
a processor configured to execute the program code to:
acquire task information of a mobile platform mounted with a plurality of loads, the task information being configured to instruct a preset load to perform a preset action;
determine the preset load from the plurality of loads according to the task information; and
control a specified load of the plurality of loads to perform a corresponding operation with respect to the preset action based on a working state of the preset load.
